(19) United States
(12) Patent Application Publication
(10) Pub. No.: US 2017/0038469 A1
(43) Pub. Date: Feb. 9, 2017

(54) DOPPLER VIBRATION VELOCITY SENSOR SYSTEM

(71) Applicant: Lovejoy Controls Corporation, Waukesha, WI (US)

(72) Inventor: KIM A. LOVEJOY, Waukesha, WI (US)

(73) Assignee: Lovejoy Controls Corporation, Waukesha, WI (US)

(21) Appl. No.: 14/819,131

(22) Filed: Aug. 5, 2015

(51) Int. Cl. G01S 15/58

(52) U.S. Cl. CPC G01S 15/586

(57) ABSTRACT

A system and method for measuring the vibrations of a test object, such as a machine shaft or other rotating equipment. The system includes a probe sensor fitting having an ultrasonic speaker and an ultrasonic microphone. The probe sensor fitting includes a temperature and relative humidity sensor. The sensor provides a real time analog output of selectable scales.

### BACKGROUND OF THE INVENTION

The present invention is directed to vibration monitoring systems, particularly systems for use with large rotating machinery. Known vibration monitoring sensors for large rotating machinery, eddy-current proximity displacement probes and spring-coil. velocity transducers, are hampered with intrinsic errors lessening their effectiveness in providing diagnostic warning or data for balancing and accurate rotor deflection monitoring to determine approaching internal contact between rotating and stationary elements thus protecting against rotor damage during start ups. For example, eddy-current proximity displacement probes may suffer from electrical run-out, magnetic run-out, surface irregularity (dents, scratches, grooves) spiking, and ill-defined calibration. Spring-coil velocity transducers suffer poor low speed outputs, mechanical resonance, and difficulty to couple to a rotating shaft without use of a contacting shaft rider which itself is spiked by surface irregularities. Therefore, there exists a need for a monitoring system having a sensor void of the aforementioned errors to thereby adequately protect and analyze major rotating equipment, such as but not limited to, steam turbines, combustion turbines, generators, fans, compressors and the like.

### SUMMARY OF THE INVENTION

The present invention is directed to a system and method for measuring the vibrations of a test object, such as a machine shaft or other rotating. equipment. The system includes a probe sensor fitting having an ultrasonic speaker and an ultrasonic microphone. The probe sensor fitting may further include a temperature and relative humidity sensor. In use, the ultrasonic speaker transmits an ultrasonic signal toward the test object. The transmitted ultrasonic signal is reflected from the test object, and is detected by the ultrasonic microphone. The sensor provides a real time analog output of selectable scales (0.5 V, 1 V or 2 V per inch/second). The present system uses the reflection of a continuous 25 KHz frequency (ultrasound) incident sound wave to detect the Doppler shift in frequency which is proportional to the target shaft velocity.

A probe for use in a system according to the present invention includes a fixed alignment ultrasonic speaker and an ultrasonic microphone located within a housing. Temperature and humidity compensation sensors and an extension tube support are also preferably included, with all components positioned at a fixed distance from a target rotating shaft. The output signal from the receiving microphone is transmitted to a control circuit which may include, among others, bandpass filters, amplifiers, a microcontroller and a primary component selective Phase Locked Loop Demodulator (PLLD) to eliminate background noise from the signal. The result is a dynamic analog signal which represents real time vibration velocity of the target shaft.

The real time continuous output signal generated through use of the methods and devices of the present invention is an improvement over present designs which routinely pulse a background calibration, and in so doing disengage from a continuous data stream.

The disengaged signal of other designs is not compatible with modern vibration analyzers which will falsely interpret the signal discontinuities as vibration phenomena.

Further, the present design preferably positions the ultrasonic microphone in exact coincidence with the opposite direction of the reflected ultrasonic waves, usually employing a fixed 30 degree incidence and 30 degree reflection positioning of the ultrasonic speaker (source) and the ultrasonic microphone (receiver). As mentioned, the present system further preferably includes a microphone input filter to remove background noise from the reflected ultrasonic waves. The microphone input filter helps insure that the Phased Lock Loop Demodulator (PLLD) receives a signal dominated by the reflected wave frequency.

As will be discussed, a system according to the present invention further preferably includes a temperature and relative humidity sensor. The temperature and relative humidity sensor detects and signals the system to compensate for variations in the ambient temperature and relative humidity of the test application. The ambient temperature and relative humidity of the application, for example a turbine monitoring atmosphere, affects the speed of sound by up to 25%. Such changes in the speed of sound directly impact the Doppler velocity. The present system compensates for both temperature and relative humidity through the use of a microcomputer controlled variable gain amplifier adjusting gain resistor array signal for AC gain based upon temperature and relative humidity feedback sensor sampling. This arrangement maintains the sensor system in acceptable calibration at all times. The present design preferably utilizes a 25.000 KHz (+/−200 Hz) incidence wave frequency.

### BRIEF DESCRIPTION OF THE DRAWINGS

FIG. 1 is a view illustrating a system according to the present invention, the system including a Doppler vibration velocity sensor, and positioned to measure the vibrations of a test object.

FIG. 2 is a perspective view of the sensor illustrated in FIG. 1.

FIG. 3 is a top plan view of the. sensor illustrated in FIGS. 1 and 2.

FIG. 4 is an end view of the sensor illustrated in FIGS. 1-3.

FIG. 5 is a partial cut away and cross sectional view of the sensor illustrated in FIGS. 1-4, taken along lines 5-5 of FIG. 2, and showing an ultrasonic speaker and an ultrasonic microphone.

FIG. 6 is a view similar to that of FIG. 5, but showing the sensor positioned to measure the vibrations of a test object.

FIG. 7 is a view similar to that of FIG. 6, but showing the sensor measuring the vibrations of a test object.

FIG. 8 is a block diagram of a control circuit used with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

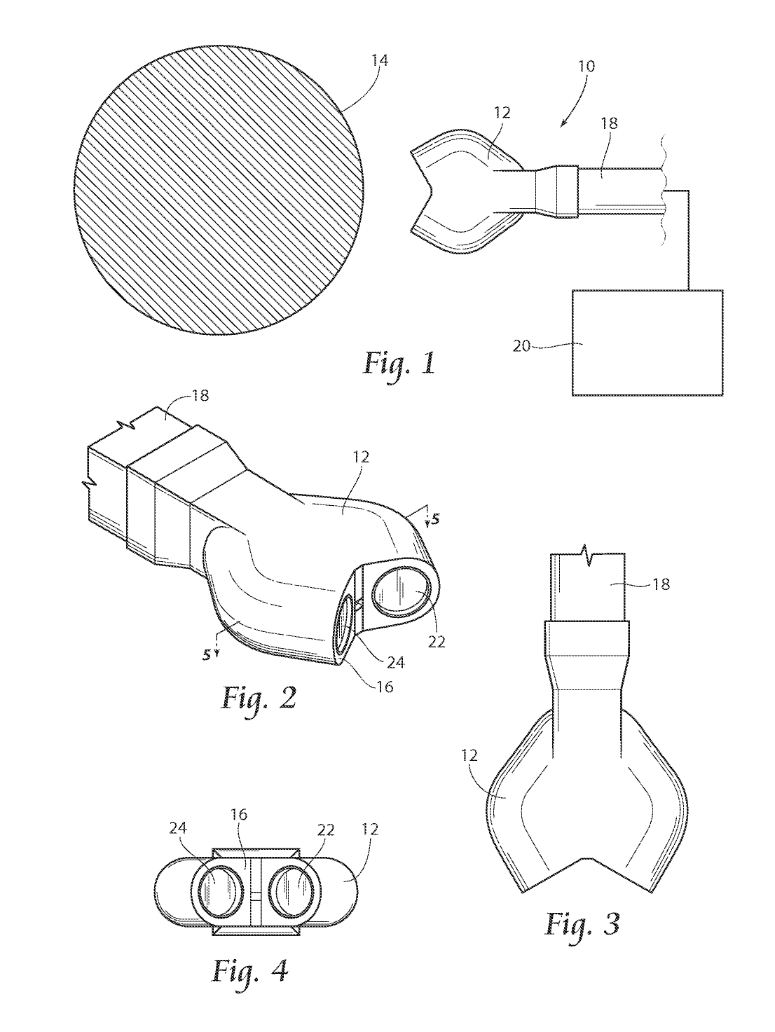

With reference to FIGS. 1 and 2, a system 10 having a probe sensor 12 according to the present invention may be seen. As shown, the system 10 provides a device and method adapted to measure the vibrations of a test object 14, such as a machine shaft or other rotating object. The system 10 includes a probe sensor 12 having a housing 16, an extension tube support 18, and a. control circuit 20. As seen in FIG. 2, a probe sensor 12 for use with the present system 10 preferably includes an ultrasonic speaker 22 and an ultrasonic microphone 24. The probe sensor 12 may further include a temperature and relative humidity sensor 26, as will be discussed (see FIG. 5). FIGS. 3 and 4 illustrate top and end views, respectively, of the probe sensor 12 shown in FIGS. 1 and 2.

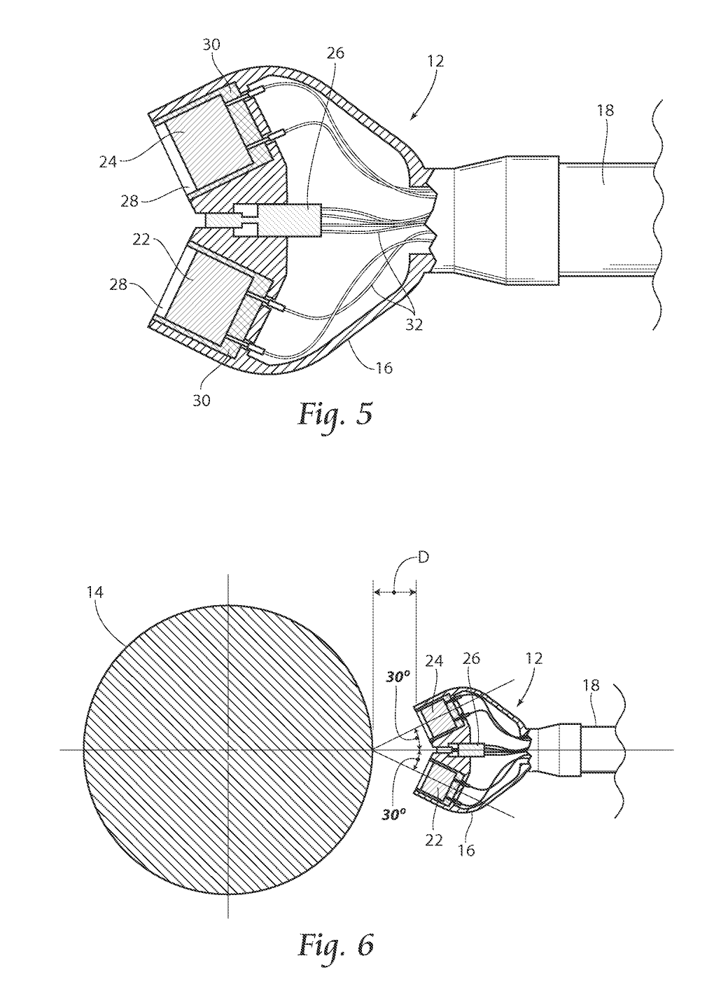

With attention now to the cross sectional view of FIG. 5, the sensor 12 with the ultrasonic speaker 22 and ultrasonic microphone 24 are seen as preferably fitted into a molded housing 16. The housing 16 includes cradle openings 28 and foam isolation jackets 30 to attenuate the incident frequency conduction in the housing 16. An extension tube 18 channels component wiring 32 to a control circuit 20 (see FIG. 8), as will be discussed. The extension tube 18 may be of any length necessary for the specific application, and is determined by the particular requirements of the housing 16 and target rotating shaft 14. As shown, the present system 10 uses a fixed alignment ultrasonic speaker 22 and ultrasonic microphone 24, each placed at a fixed distance D (see FIG. 6) from one another and the test object 14. As mentioned, the sensor 12 preferably includes a temperature and relative humidity sensor 26. The temperature and relative humidity sensor 26 detects and compensates for temperature and relative humidity, since the ambient temperature and relative humidity affects the speed of sound by up to 25% in the application (e.g. turbine monitoring) atmosphere, and changes in the speed of sound directly impact the Doppler velocity. The system 10 is adapted to compensate for both temperature and relative humidity detected by the temperature and relative humidity sensor 26. A microcontroller 56 controls a variable gain amplifier 50 and adjusts a gain resistor array 60 signal for AC gain based upon temperature and relative humidity feedback sensor 26 sampling. This retains the sensor system 10 in acceptable calibration at all times. To reduce background noise, the system 10 may preferably include other components, including filters 34, 52 such as a bandpass filter on the receiving microphone signal, mechanical acoustical isolation, such as the jackets 30 shown, and a primary component selective Phase Locked Loop demodulator (PLLD) 42.

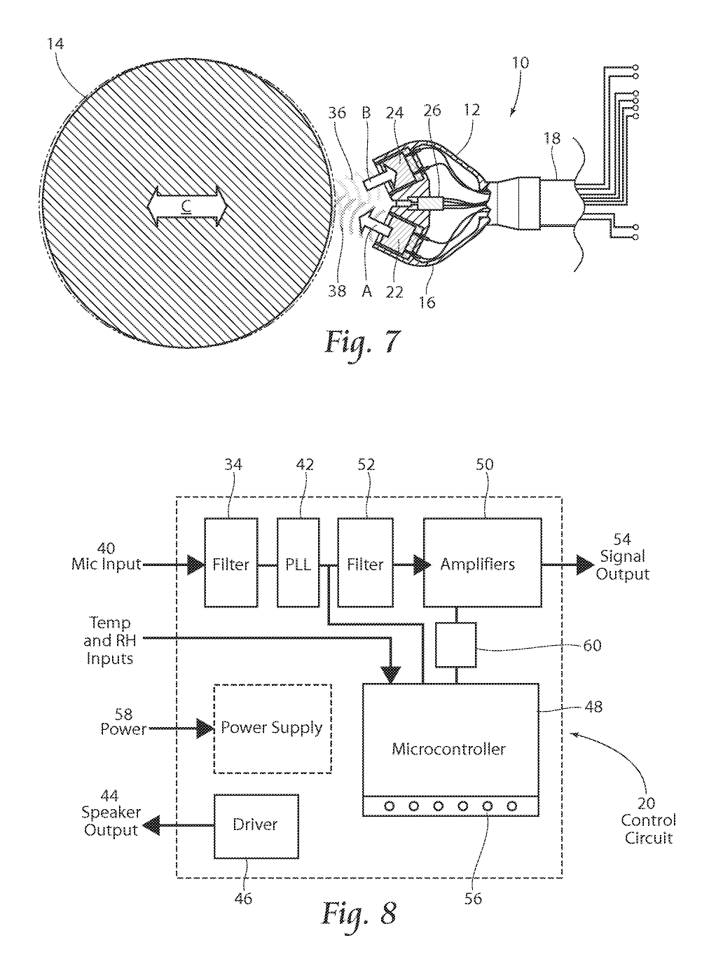

As seen particularly in FIGS. 6 and 7, the ultrasonic microphone 24 of the present system 10 is preferably positioned in exact coincidence with the opposite direction of the reflected ultrasonic waves 36. As shown in FIG. 6, a preferred position is a fixed 30 degree incidence and 30 degree reflection positioning of the ultrasonic speaker 22 and ultrasonic microphone 24. The probe 12 is further preferably positioned a predetermined distance D, from the target test object 14. An example distance D, may be 1.0″ with a +/−0.25 inch tolerance.

In use, and as shown in FIGS. 7 and 8, the ultrasonic speaker 22 transmits an ultrasonic signal 38, preferably a 25.000 KHz (+/−200 Hz) incidence wave frequency, toward the target object 14 in the direction of arrow A. The ultrasonic signal 38 is transmitted by a speaker output 44 driven by driver 46 (see FIG. 8). As previously mentioned, the present system 10 uses the reflection of the continuous 25.000 KHz frequency (ultrasound) incident sound wave to detect the Doppler shift in frequency which is proportional to the target shaft 14 velocity. The transmitted ultrasonic signal 38 is reflected from the test object 14 as reflected waves 36 in the direction of arrow B, and is detected by the ultrasonic microphone 24. Any oscillations or fluctuations C in the rotating shaft 14 will cause variations in the reflected ultrasonic wave 36 at the ultrasonic microphone 24. An output signal from the ultrasonic microphone 24 is then connected to a control circuit 20 by way of wiring 32 or other conventional means, through a microphone input 40. The output signal from the ultrasonic microphone 24 moves through a microphone input filter 34 to remove background noise from the reflected ultrasonic waves 36. The microphone input filter 34 helps insure that the PLLD 42 receives a signal dominated (eg: greatest magnitude) by the reflected wave frequency. The output signal from the ultrasonic microphone 24 is additionally processed by the PLLD 42 and microcontroller 48 to further refine the signal. The refined signal is passed through an output filter 52 and at least one amplifier 50 prior to exiting as an analog output signal 54. The present system 10 provides a real time analog output of selectable scales (0.5 V, 1 V or 2 V per inch/second). Since the Phase Lock Looped demodulated output after low pass filtering is in direct proportion to the target shaft velocity, it represents a real time signal useful for analysis and unburdened by breaks or discontinuities with all gain compensation adjustments affecting only the AC peak-to-peak voltage amplitude and never the primary signal phase nor frequency. The real time continuous sensor analog output 54 is unlike known systems which routinely pulse a background calibration and in so doing disengage from a continuous data stream. The disengaged signal of other designs is not compatible with modern vibration analyzers which will falsely interpret the signal discontinuities as vibration phenomena.

With further attention to FIG. 8, a control circuit 20 for use with the present system 10 and method may be seen. As shown, the control circuit 20 receives the microphone signal 36 by way of the microphone input 40. The ultrasonic microphone signal 36 is inputted to filters 34, 52. Filters 34, 52 used with the present system 10 may preferably include an input filter 34 and an output filter 52. The input filter 34 may be a second order positive feedback band pass filter with a bandwidth of 40 Hz, for example. As mentioned, filter 34 is used to remove background noise from the reflected ultrasonic waves 36. The output filter 52 may be a second order positive feedback low pass filter having a zero DC offset and an AC gain of 4.00, by way of non-limiting example. Use of the filters 34, 52 assures that the phased lock loop demodulator 42 (PLLD) receives a signal dominated by the reflected wave 36 frequency. As mentioned, a microcontroller 48 receives information from the temperature and humidity sensor 26 and maintains environmental compensation control. The microcontroller 48 also adjusts amplifier gain as well as provides control of performance through LED indicators 56. An amplifier 50 includes an optional sensor scale to allow signal adjustment for the incident angle. Additional components provide power 58 to the control circuit 20 and an ultrasonic sine wave generator, such as the driver 46 for the ultrasonic speaker 22.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A system for measuring vibration velocity of a rotating shaft including:
a probe sensor having a housing, said housing including a first cradle opening and a second cradle opening;
an ultrasonic speaker, said ultrasonic speaker being positioned in said first cradle opening; and
an ultrasonic microphone, said ultrasonic microphone located within said second cradle opening.

2. The system of claim 1 wherein said probe sensor further includes a temperature and humidity compensation sensor.

3. The system of claim 1 wherein at least one of said first cradle opening and said second cradle opening includes an isolation jacket.

4. The system of claim 2 wherein said probe sensor further includes an extension tube support.

5. The system of claim 2 wherein said probe sensor is positionable at a fixed distance from said target rotating shaft.

6. The system of claim 2 wherein said ultrasonic speaker is configured to transmit an ultrasonic signal toward said target rotating shaft.

7. The system of claim 6 wherein said ultrasonic microphone is configured to receive a reflected ultrasonic signal from said target rotating shaft.

8. The system of claim 7 wherein said reflected ultrasonic signal is transmittable to a control circuit, said control circuit including at least one bandpass filter and at least one amplifier.

9. The system of claim 8 wherein said control circuit further includes a microcontroller and a primary component selective phase locked loop demodulator.

10. A method for measuring the vibration velocity of a rotating shaft including the steps of:
providing a probe sensor having a housing, said housing including a first cradle opening and a second cradle opening;
providing an ultrasonic speaker, said ultrasonic speaker being positioned in said first cradle opening;
providing an ultrasonic microphone, said ultrasonic microphone located within said second cradle opening;
providing a temperature and humidity compensation sensor;
transmitting an ultrasonic signal from said ultrasonic speaker toward said rotating shaft;
reflecting said ultrasonic signal from said rotating shaft as a reflected ultrasonic signal to said ultrasonic microphone;
transmitting said reflected ultrasonic signal through said temperature and humidity compensation sensor to compensate for reflected ultrasonic signal gain;
transmitting said reflected ultrasonic signal from said temperature and humidity compensation sensor to a control circuit; and
outputting an analog output signal from said control circuit.

11. The method of claim 10 further including the steps of providing a microphone input filter and processing said reflected ultrasonic signal through said microphone input filter.

12. The method of claim 11 further including the steps of:
providing a phase lock loop modulator;
providing a microcontroller; and
processing said reflected ultrasonic signal using said phase lock loop modulator and said microcontroller.

13. The method of claim 12 further including the steps of:
providing an output filter;
providing at least one amplifier; and
using said output filter and said at least one amplifier to process said reflected ultrasonic signal.

14. The method of claim 10 further including the step of providing at least one of said first cradle opening and said second cradle opening with an isolation jacket.

15. The method of claim 10 wherein said probe sensor is positionable at a fixed distance from said rotating shaft.

16. The method of claim 10 wherein said analog output signal is in direct proportion to a velocity of the rotating shaft.
